(19) United States
(12) Patent Application Publication
(10) Pub. No.: US 2004/0247263 A1
(43) Pub. Date: Dec. 9, 2004

(54) Method of making a covered wire-shaped body

(75) Inventors: Masashi Ohkura, Kanagawa (JP); Takashi Tanaka, Kanagawa (JP); Shigehisa Ishigami, Kanagawa (JP); Keigo Odawara, Kanagawa (JP)

Correspondence Address: McDERMOTT, WILL & EMERY, 600 13th Street, N.W., Washington, DC, 20005-3096, US

(73) Assignee: SUMITOMO ELECTRIC INDUSTRIES, LTD.

(21) Appl. No.: 10/842,470

(22) Filed: May 11, 2004

(30) Foreign Application Priority Data
Jun. 5, 2003 (JP) 2003-161061

(51) Int. Cl. G02B 6/44

(52) U.S. Cl. 385/100; 385/128

(57) ABSTRACT

The present invention provides a method of making a covered wire-shaped body, in which a foreign substance or particle such as dust or debris adhering to a pre-cover wire-shaped body can easily be removed. This method comprises: running a wire-shaped body through a mesh which is made of flexible threads and arranged at a position upstream of a covering device; covering the wire-shaped body with a resin by said covering device; and hardening the resin.

### BACKGROUND OF THE INVENTION

1. Field of the Invention

The present invention relates to a method of making a covered wire-shaped body, and is suitable for making an optical fiber cable or optical fiber ribbon.

2. Description of the Background Art

An optical fiber ribbon having two or more optical fibers arranged in parallel and integrally covered with resin is disclosed in Japanese patent application publication No. H8-43694. The two or more optical fibers are assembled by an assembling die, introduced into a crosshead, and integrally covered with resin. If a foreign substance or particle such as dust or debris is adhered to the optical fiber, the optical fiber tends to be damaged or broken. Even if the optical fiber is not damaged or broken, the adhered substance or particle gives a localized strain to the optical fiber and causes a loss increment.

By using an air wiper system to blow off an adhered substance or particle with air, it is possible to remove a foreign substance or particle which has adhered to a wire-shaped body in a dry situation, but a foreign substance or particle which has adhered to it by electrostatic force or moisture can not be removed. With a known method in which a wire-shaped body is nipped by two felt blocks so that an adhered substance or particle on the wire-shaped body is wiped off with the felt blocks, it is difficult to continue removing the substance or particle for a sufficiently long period of time as needed. Furthermore, when a wire-shaped body is an optical fiber, it is difficult to set a suitable pressing force for a felt block not to cause breakdown of the optical fiber.

### SUMMARY OF THE INVENTION

It is an object of the present invention to provide a method of making a covered wire-shaped body, in which a foreign substance or particle, such as dust or debris, adhered to a wire-shaped body prior to application of a covering material thereto can easily be removed. Hereinafter a wire-shaped body in a state prior to application of a covering material thereto is referred to as a “pre-cover wire-shaped body”. Note that the term “covered wire-shaped body” as used herein includes any covered body in a shape of wire, cable, ribbon, or the like, in which one or more pre-cover wire-shaped bodies are assembled.

In order to achieve the object, a method of making a covered wire-shaped body according to one embodiment of the present invention comprises: running a pre-cover wire-shaped body through a mesh which is made of flexible threads and arranged in an upstream of a covering device; covering the pre-cover wire-shaped body with a resin using the covering device; and hardening the resin.

Advantages of the present invention will become readily apparent from the following detailed description, which illustrates the best mode contemplated for carrying out the invention. The invention is capable of other and different embodiments, the details of which are capable of modifications in various obvious respects, all without departing from the invention. Accordingly, the drawings and description are illustrative in nature, not restrictive.

### BRIEF DESCRIPTION OF THE DRAWING

The present invention is illustrated by way of example, and not by way of limitation, in the figures of the accompanying drawings in which like reference numerals refer to similar elements.

FIG. 1 is a schematic diagram showing a method of making a covered wire-shaped body according to a first embodiment of the present invention.

FIGS. 2A and 2B are schematic views showing meshes used in an embodiment of the present invention.

FIG. 3A is a schematic view showing a mesh and an optical fiber that runs through the mesh, and FIG. 3B is an enlarged view showing a portion through which the optical fiber runs.

FIG. 4 is a schematic diagram showing a method of making a covered wire-shaped body according to a second embodiment of the present invention.

FIG. 5 is a cross sectional view showing an example of an optical fiber cable in which an optical fiber is covered with a thermoplastic resin.

FIG. 6 is a cross sectional view showing an example of an optical fiber ribbon in which optical fibers are covered with an ultraviolet hardening resin.

### DETAILED DESCRIPTION OF THE INVENTION

FIG. 1 is a schematic diagram showing a method of making a covered wire-shaped body according to a first embodiment of the present invention. The first embodiment relates to a method in which an over-coated optical fiber (a covered wire-shaped body) 7 is made by coating one optical fiber (a pre-cover wire-shaped body) 2 with a thermoplastic resin. In this specification, an optical fiber means a glass fiber covered with a protective coating or a glass fiber covered with a protective coating and a thin coloring layer coated thereon. The outer diameter of the glass fiber is, for example, 125 μm and the outer diameter of the optical fiber is, for example, 250 μm.

The optical fiber 2 is paid-off from a supply stand 1. The supply stand 1 may, through a dancer roller that is not illustrated in FIG. 1, pay out the optical fiber 2 that is wound on a supply-reel. The optical fiber 2 thus paid out is introduced into a crosshead (covering device) 4 after the optical fiber 2 has run through a mesh 3, which is made of flexible threads and arranged at a position immediately upstream of the crosshead 4, so that a foreign substance or particle such as dust or debris adhering to the optical fiber 2 is removed. Thermoplastic resin is supplied from an extruder 5 to the crosshead 4, and the optical fiber 2 is covered with the resin. The over-coated optical fiber 7 is cooled in a cooling trough 6, pulled by a capstan (not illustrated in the figure), and wound on a take-up bobbin at a take-up machine 8 through another dancer roller (not illustrated). In addition, a coloring device for applying a coloring layer on the protective coating may be arranged between the mesh 3 and the crosshead 4.

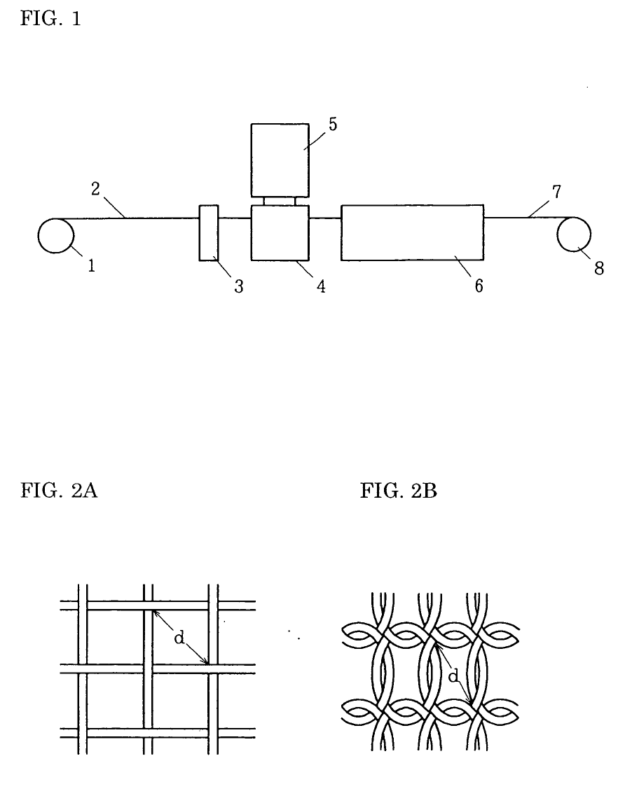

FIGS. 2A and 2B are schematic views showing meshes used in an embodiment of the present invention. FIG. 2A shows an example of a textile mesh and FIG. 2B shows an example of a knit mesh. In both examples, an interval (diagonal length of a mesh opening) d between threads 3a is desirably equal to or less than a diameter of the optical fiber 2.

When the interval d is larger than the diameter, which is usually 250 μm, of the optical fiber 2, the thread 3a does not come in contact with the optical fiber 2 in all laps and a gap is induced. Even if the interval d is smaller than 250 μm, when it is larger than 200 μm, a gap is also induced such that an adhering substance or particle cannot be removed from the surface of the optical fiber at the gap. Therefore, the interval d is preferably not more than 200 μm. When an optical fiber having a diameter of 250 μm runs through a mesh opening having an interval d of not more than 200 μm, the thread contacts closely to the optical fiber in all laps, and the adhering substance or particle can be removed without damaging the protective coating of the optical fiber. Note that any method of knitting or weaving can be applicable to the mesh used in the present invention.

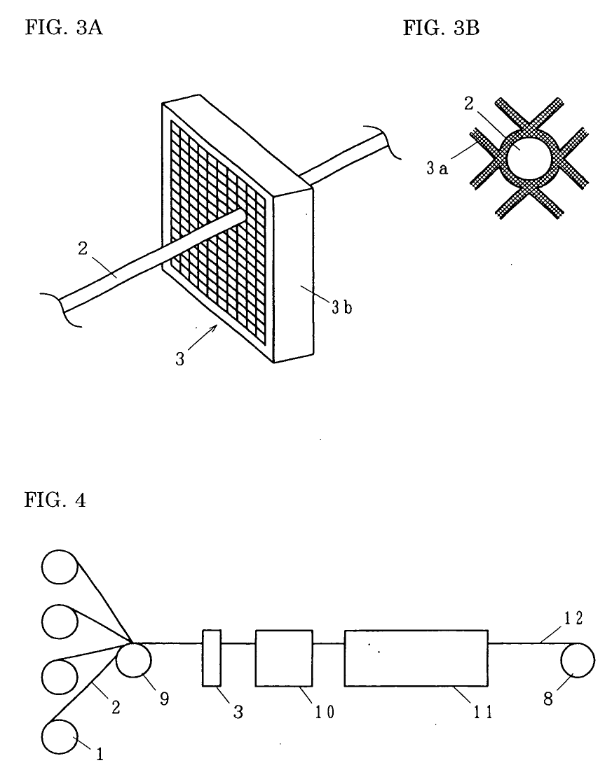

FIG. 3A is a schematic view showing a mesh through which an optical fiber runs, and FIG. 3B is an enlarged view showing a portion through which an optical fiber runs. The mesh is a kind of cloth made of flexible threads, and set on a frame 3b. When the optical fiber 2 runs through the mesh, the thread 3a is pulled and is elongated. When the optical fiber 2 runs in this situation for a predetermined duration, the thread wears down, if a tensile strength of the thread 3a is small. In order to continue running the optical fiber 2 through the mesh 3, the tensile strength, which is defined in JIS L2510, of the thread 3a, is preferably more than 3N. If a mesh is made of a thread having a tensile strength not less than 3N, the thread does not break due to wear when an optical fiber continuously runs through the mesh, and it can be used for removing an adhering substance or particle for a prolonged period of time.

Abrasion resistance and flexibility are required of a thread that forms a mesh. As a result of various kinds of evaluation, the inventors have found that the thread made of synthetic fiber is suitable, and in particular a composite material made of a mixed yarn of polyamide synthetic fiber and polyurethane fiber is suitable. A mesh made of a thread of this composite material can remove an adhering substance or particle without damaging the protective coating of the optical fiber, even if the thread touches a surface of an optical fiber.

FIG. 4 is a schematic diagram showing a method of making a covered wire-shaped body according to a second embodiment of the present invention. The second embodiment relates to a method in which two or more optical fibers 2 are arranged in parallel and integrally covered with resin and an optical fiber ribbon 12 is thus made.

The optical fibers 2, which are paid out from a supply reel on a supply stand 1 through a dancer roller (not illustrated in FIG. 4), are arranged by rollers 9 so as to run through a mesh 3 disposed at a position just upstream of the covering device 10 such that a foreign substance or particle such as dust or debris adhering to the optical fibers 2 is removed, and thereafter the optical fibers 2 are introduced into a covering device 10. At the rollers 9 the optical fibers are arranged at intervals such that the optical fibers do not touch each other at the mesh 3, and each of the optical fibers runs through the mesh 3 at different positions. Ultraviolet (UV) hardening resin is supplied from a resin-supplying unit that is not illustrated in FIG. 4 to the covering device 10. The optical fibers 2 are arranged in parallel to come into close contact with the adjacent fibers and are covered with the UV hardening resin at the covering device 10 to form an optical fiber ribbon 12. The UV hardening resin on the optical fibers is irradiated with UV rays and cured in a UV hardening unit 11 and the optical fiber ribbon 12 is pulled by a capstan (not illustrated in FIG. 1) and wound on a take-up bobbin at a take-up machine 8 through another dancer roller (not illustrated in FIG. 4).

The number of optical fibers is not limited to four, which is shown in the second embodiment. In addition, an assembling die may be inserted between the mesh 3 and the covering device 10 so that the optical fibers are arranged in parallel to come into close contact with the adjacent fibers.

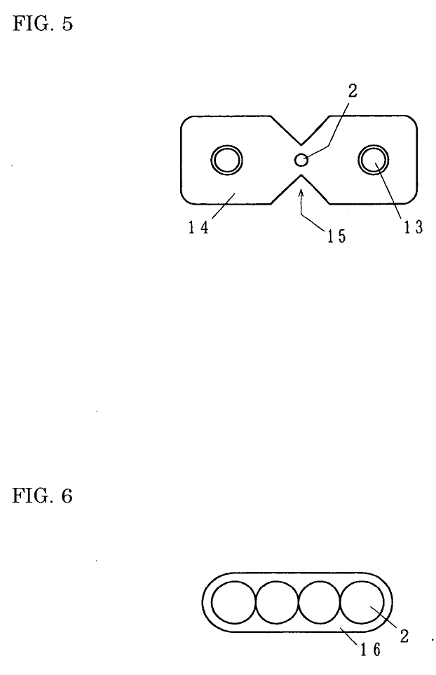

FIG. 5 is a cross sectional view showing an example of an optical fiber cable in which an optical fiber is covered with a thermoplastic resin. This optical fiber cable includes an optical fiber 2 and tension members 13 disposed at both sides of the optical fiber and the optical fiber 2 and tension members 13 are integrally covered with thermoplastic resin 14. On the outer surface of the thermoplastic resin 14, two longitudinal notches 15 are formed for the purpose of ease of removal of the optical fiber 2. In the method of making the optical fiber cable, the tension members are also introduced into the crosshead so as to be integrally covered with thermoplastic resin in the manner as shown in FIG. 1. Thus, the optical fiber cable having the cross-sectional structure shown in FIG. 5 is produced. An adhering substance or particle on the optical fiber 2 is removed by the same process of running through a mesh as described in FIG. 1 before the optical fiber 2 is introduced into the crosshead.

Using five kinds of meshes having a thread interval (diagonal length of a mesh opening) and tensile strength shown in Table I, the optical cables having a structure shown in FIG. 5 and a length of 1 km were produced by way of trial. Single mode optical fiber (SMF) is used as the optical fiber 2. Thirty optical fiber cables were produced for each of the meshes, and the transmission loss of the optical fiber cables was measured. The average values of the transmission losses are shown in Table I.

TABLE I

| | | | | | | Comparative |
|---|---|---|---|---|---|---|
| | No. | Ex. 1 | Ex. 2 | Ex. 3 | Ex. 4 | example |
| Mesh | Thread in- | 200 | 100 | 300 | 200 | — |
| | terval μm | | | | | |
| | Tensile | 3.5 | 4 | 3.5− | 2 | — |
| | strength N | | | | | |
| | Loss dB/km | 0.19 | 0.19 | 0.25 | 0.25 | 0.30 |

In Examples 1 and 2, transmission loss of the optical fibers was small, the optical fibers were not broken, and the thread of the mesh did not break. In Example 3, two optical fiber cables had a transmission loss of more than 0.25 dB/km and were in tolerance level. In Example 4, a thread of the mesh broke during the production of the 28th optical fiber cable, and the durability of the mesh was an acceptable level. In the comparative example, the transmission loss of the optical fiber cable was large, and two of thirty optical fibers were broken. These examples show that the thread interval in a mesh is preferably less than 200 μm and a tensile strength of a thread is preferably not less than 3 N. It was found that if a wire-shaped body is an optical fiber, the breakage of the optical fiber covered with resin and an increase of transmission loss can be prevented.

FIG. 6 is a cross sectional view showing an example of an optical fiber ribbon in which optical fibers are covered with an ultraviolet hardening resin. The optical fiber ribbon 12 is made according to the second embodiment of the present invention.

Optical fiber ribbons having a cross sectional structure shown in FIG. 6 were produced by way of trial and evaluated. SM fibers were used as the optical fibers for evaluation. Thirty optical fiber ribbons were produced for each of Examples 5 and 6 and the average values of the respective transmission losses are shown in Table II.

TABLE II

| | No. | Ex. 5 | Ex. 6 |
|---|---|---|---|
| Mesh | Thread interval μm | 200 | 100 |
| | Tensile strength N | 3.5 | 4 |
| | Loss dB/km | 0.193 | 0.193 |

In both Examples the transmission loss was small, no breakage of the optical fibers was induced, the tensile strength was sufficiently large, and the meshes did not break. These two examples also show that a distance between threads in a mesh is preferably less than 200 μm and a tensile strength of a thread is preferably more than 3 N.

While the present invention has been described in connection with what is presently considered to be the most practical and preferred embodiments, the invention is not limited to the disclosed embodiments, but on the contrary, is intended to cover various modifications and equivalent arrangements included within the spirit and scope of the appended claims.

The entire disclosure of Japanese Patent Application No. 2003-161061 filed on Jun. 5, 2003 including specification, claims, drawings and summary are incorporated herein by reference in its entirety.

What is claimed is:

1. A method of making a covered wire-shaped body having at least one wire-shaped body, comprising:
running a pre-cover wire-shaped body through a mesh which is made of flexible threads and arranged at a position upstream of a covering device,
covering said pre-cover wire-shaped body with a resin by said covering device, and hardening said resin.

2. A method of making a covered wire-shaped body according to claim 1,
wherein said pre-cover wire-shaped body is an optical fiber.

3. A method of making a covered wire-shaped body according to claim 1,
wherein a diagonal length of a mesh opening in said mesh is equal to or less than a diameter of said pre-cover wire-shaped body.

4. A method of making a covered wire-shaped body according to claim 1,
wherein a tensile strength of said thread is not less than 3 N.

5. A method of making a covered wire-shaped body according to claim 1,
wherein said thread is a composite material made of a mixed yarn of polyamide synthetic fiber and polyurethane fiber.

6. A method of making a covered wire-shaped body according to claim 1,
wherein said resin is thermoplastic resin or ultraviolet hardening resin.
